(19) United States
(12) Patent Application Publication
(10) Pub. No.: US 2015/0088630 A1
(43) Pub. Date: Mar. 26, 2015

(54) SYSTEM AND METHOD FOR VIRAL PURCHASING

(71) Applicants: Thomas Jason Taylor, San Clemente, CA (US); Reyhan Nihat Pasinli, Aliso Viejo, CA (US)

(72) Inventors: Thomas Jason Taylor, San Clemente, CA (US); Reyhan Nihat Pasinli, Aliso Viejo, CA (US)

(21) Appl. No.: 14/464,648

(22) Filed: Aug. 20, 2014

Related U.S. Application Data
(60) Provisional application No. 61/881,246, filed on Sep. 23, 2013.
(60) Provisional application No. 61/881,287, filed on Sep. 23, 2013.

(51) Int. Cl. G06Q 30/02; G06Q 50/00

(52) U.S. Cl. CPC G06Q 30/0222; G06Q 50/01
USPC 705/14.23

(57) ABSTRACT

A system and method are provided for encouraging online shoppers to share online purchase transactions. Included are online advertisements or offers at the point of checkout. These offers indicate an incentive for sharing information about the online purchase on one or more social network platforms of the online shopper. The system may also include a pre-made or subsequently created video component featuring the product or a statement or opinion about the product. When the online shopper indicates a willingness to share in order to receive the incentive the video component featuring the product or a link thereto is displayed on the online shopper's social network platform as a posting in a newsfeed, on a profile page, or as a status update for the social network connections of the online shopper to see. The social network connections can then purchase, share, redeem and offer incentives as well.

### RELATED APPLICATION(S)

This application claims the benefit of U.S. patent application Ser. No. 61/881,246 entitled “SYSTEM AND METHOD FOR PURCHASING BY SOCIAL NETWORK STATUS UPDATE OR POST,” filed on Sep. 23, 2013; and U.S. patent application Ser. No. 61/881,287entitled “SYSTEM AND METHOD FOR VIRAL PURCHASING,” filed on Sep. 23, 2013; the substance of which are incorporated herein in their entirety.

### FIELD OF THE INVENTION

The present invention relates to internet commerce and social networking. More particularly, the present invention relates to social commerce which combines these two fields. Most particularly, the present invention relates to encouraging purchaser promotion of purchases in a social commerce environment.

### BACKGROUND

The internet is often used for purchases of all sorts of products and services without geographic limitation to traditional brick and mortar stores. This leads to increased variety of offerings to the individual internet-savvy consumer along with better prices due to increased competition, fewer middlemen, reduced overhead, and resale not to mention savings of gas and time compared to traditional in-person shopping. Websites likely eBay, Amazon, and Craigslist proliferated and payment processors like PayPal took care of the backend in an area of internet commerce.

More recently, social networking websites have emerged as a powerful interpersonal communication medium. As used herein the term and adjective “social networking” as used with website/forum/platform is used broadly to include all variations of networking to include, for example, professional networking, personal networking, special interest forums, blogs, short messaging and so on. In increasing numbers individuals are signing up to join various social networking platforms and sharing information about themselves, making new friends or keeping in touch with existing friends/classmates/family/colleagues/coworkers and other real-life connections, and forging new relationships, even with unknown individuals across the globe or friends-of-friends and higher order connections that may or more not leave the virtual realm to meet face-to-face.

The benefits of social network are numerous in that it provides an easy way to stay in touch with many people simultaneously, serves as a news resource, lets certain things be known to everyone (or selected groups) in a user's network without taking the time to tell each person, provides a platform to ask questions with real people answering, allows a user to answer others' questions as a starting point for a future relationship, and provides an outlet to advertise a user or a business for free or low cost.

The value of social media in rapid dissemination of information is enormous. For example, in 2012 the humanitarian group Invisible Children released a short film documenting the activities of the international fugitive Joseph Kony. Word of the video went viral on social networks and in less than a week after launch, the video had been viewed over 100 million times. Another example of the power of social media is the fact that the term “went viral” does not require quotation marks. Also in 2012, the Nike shoe corporation launched the #makeitcount social media campaign and saw an increase in profits of 18%. Efforts like this inspired other for-profit or for-gain advertising on social media: nearly all political campaigns now have social media operations.

More recently, internet commerce has begun to merge with social networking in the form of individuals making purchase decisions and being directed to purchase products of interest based on referrals from friends or connections in a social networking forum. After all, before the internet and still today many people make purchasing decisions based on things seen and liked bought by friends, relatives, and co-workers and based on talking to these individual people about their experiences with a particular product. With more people spending more time looking at a computer, tablet computer, smart phone, or other internet connected device through which they can check-in with their social networking forums of interest, it comes as no surprise that purchase decisions of today and of the future will be strongly influenced by events in social networking forums. Specifically, if a user is online on any of of their preferred social networking websites and they see a friend, someone whom they follow, a follower, a connection, a fellow group member, or other direct or indirect contact (there are numerous terms and types of communication relationships) and that individual is posting about something which the user then notices and likes, or which they recommend, or just the mere fact that they purchased something, this tends to increase interest in the product, or merely create brand or product awareness in the user.

There are various types of social media advertising campaigns. The prototypical type of campaign is the electronic word of mouth campaign or eWOM, in which users are encouraged to proactively post (communicate) about a company. A slightly more artificial campaign type is the COBRA, consumer online brand related activity campaign, in which consumers are urged to post regarding their brand loyalty. These campaigns might be of low cost in some circumstances, with the motivator or incentive merely being a prize or even just social proof, that is, the tendency of individuals to assume that the behavior of others around them must be the correct behavior, after which imitation is likely.

Nonetheless, there are some drawbacks to purchasing products online. For example, many online sellers charge the purchaser for shipping and sometimes charge for online order or payment processing. Another non-monetary drawback is the inability to accurately access product quality due to seeing only a picture and being unable to physically inspect the product in person as one would do in a traditional brick and mortar store environment. If there is still a savings by purchasing a product online together with the shipping and online transaction costs than many people will still purchase online as long as they are familiar with a product they are purchasing, trust someone else's judgment on a product with which they are not familiar (e.g. online reviews), the company has a friendly return policy, or they are not risk averse.

A drawback to online transactions for sellers is that they do not always benefit from the physical advertising real world shoppers can do by visiting a store in person and then walking around town with shopping bags advertising where they have spent their money. In this manner, ordinary shoppers provide a subtle yet visible endorsement to brick and mortar stores.

It would be desirable to provide additional incentives for online consumers to purchase products online and to promote their online purchases to those they may be more likely to influence. It would also be desirable to provide ways for online shoppers to get to know the product they are purchasing better without actually being in the same physical place as the product or to have more reason to trust the product. Finally, it would be desirable to provide ways for online sellers to use online purchasers as online advertisers for products that they have purchased in the specific channels where they are likely to have the greatest impact. The present invention meets these and other needs.

It would further be preferable to provide a new paradigm for social network marketing, so as to provide advertisers a new channel of communication with social network users.

### SUMMARY OF THE INVENTION

The above-discussed disadvantages of the reference art are overcome by the system and method of the present invention that provides a simple, yet elegant solution to incentivize online purchases and feature online products in videos. The present invention may be used with any social media platform/tool now known or later devised which meets the fundamental criteria of allowing users to post communications which are viewed by other users. Thus most blogs, Instagram, Twitter, Facebook, LinkdIn, Google+, Pinterest, similar services in other languages and so on all could be considered to fall within the scope of the framework within which the present invention operates. In addition, other tools which are not technically social media are in fact integral to the social media ecosystem, such as Youtube, Dailymotion, Digg, Reddit, Delicious, and so on.

As used herein, “POC” refers to point-of-checkout process, the process at which shopping ends and actual payment begins. “POC advertisement” refers to an advertisement a user receives while in any stage of the POC process.

According to a first aspect the invention provides a system for encouraging an online shopper to share information about an online purchase transaction, including an online advertisement at the point of checkout that indicates an incentive for sharing information about a purchase of a product on one or more social network platform; and a video component featuring the product or a statement or opinion about the product in a video. The video component featuring the product or a link thereto is configured to be displayed on the online shopper's social network platform as a posting in a newsfeed, on a profile webpage, or as a status update for one or more social network connection of the online shopper to see when the online shopper indicates a willingness to share in order to receive the incentive. The system may also include a second online advertisement that indicates an incentive for sharing information about the purchase of the product on one or more social network platform, wherein the second online advertisement is configured to be displayed along with the video component featuring the product on the online shopper's social network platform as a posting in a newsfeed, on a profile webpage, or as a status update for one or more social network connection of the online shopper to see when the online shopper indicates a willingness to share in order to receive the incentive.

The online advertisement may provide an additional incentive for sharing on more than one social network platform. Further, a desirability of an incentive to the online shopper may be a function of a number of social network connections of the online shopper. For example, the more social network connections that the online shopper has to potentially see the video component featuring the product, the greater a number of incentives that are offered to the online shopper. Or, the more social network connections that the online shopper has to potentially see the video component featuring the product, the more desirable the incentive is to the online shopper (e.g. 40% discount instead of 25% discount, or buy one get one free instead of 40% discount).

The video may be pre-made and ready to be shared immediately upon the online shopper's indication to share and receive the incentive. Additionally, the video component displayed on the online shopper's social network may be selected by the online shopper from among multiple videos featuring the product or a statement or opinion about the product. In this manner, the online shopper can share a video that he/she is more likely to feel comfortable with their social network connections seeing, considering the type of social network or the type of connections. For example, the online shopper may want to share a funny video on a personal Facebook account but opt for a more sophisticated video to share on Linkedin. What is appropriate for social network connections on one social network to see may not be a wise choice for different social network connections on another social network.

The video may be created after the online shopper indicates a willingness to share and receive the incentive. For example, the video may be created by the online shopper, e.g. with their smartphone video recorder camera. Or, the video may be created by an online merchant. Or, the video may be created by a third party that hosts the system.

According to a second aspect the invention provides a method for encouraging an online shopper to share information about an online purchase transaction that includes offering an incentive to the online shopper after an online product item has been added to an online shopping cart of the online shopper but prior to checkout. The method further includes displaying a video featuring the product on a social network platform of the online shopper when the online shopper accepts the incentive.

The method may further include displaying a second offer of an incentive for purchasing the product on the social network platform of the online shopper when the online shopper accepts the incentive. The second offer is displayed as a posting in a newsfeed, on a profile webpage, or as a status update for one or more social network connection of the online shopper to see. The second offer may be displayed along with the video featuring the product.

The method may also include clicking on the video featuring the product by a social network connection of the online shopper, and then purchasing the product by the social network connection of the online shopper. The method may further include clicking on the second offer by a social network connection of the online shopper, and then purchasing the product by the social network connection of the online shopper.

The method may further include sharing information about the purchase by the social network connection of the online shopper on a social network platform of the social network connection. In this manner publicity about the product and purchases thereof multiplies exponentially.

The information shared may be a video featuring the product. Additionally or alternatively, the information shared may be a third offer of an incentive for purchasing the product on the social network platform of the social network connection of the online shopper.

A sales system for encouraging an online shopper to share information about an online purchase transaction, the sales system for use with a first social network, the first social network having a plurality of users including first and second users, the first social network offering such users the ability to post to the first social network, the sales system further for use with an online purchase system, the online purchase system having a point-of-checkout process, the sales system comprising: a POC advertisement inserted into such point-of-checkout process, the POC advertisement offering to such first user an incentive for posting information about the purchase of a first product by such first user; a social advertisement selection module offering to such first user at least one social advertisement component for the sharing of information, the social advertisement component having a statement/opinion about the product; a social advertisement component insertion module which posts the social advertisement component to the first social network as a post of such first user.

It is therefore another aspect, advantage, embodiment and objective of the present invention to provide a method of online sales, wherein the social advertisement component further comprises a video component and the social advertisement selection module further comprises a video selection module and the social advertisement component insertion module further comprises a video component insertion module.

It is therefore another aspect, advantage, embodiment and objective of the present invention to provide a method of online sales, wherein the social advertisement component insertion module further posts a companion advertisement component to such first social network as a post of such first user, the companion advertisement displayed along with the video component.

It is therefore another aspect, advantage, embodiment and objective of the present invention to provide a method of online sales, wherein the video component is one member selected from the group consisting of: a video file, and embedded video player, a link to a video file, a link to a video player, a link to a video publically posted to a video sharing service and combinations thereof.

It is therefore another aspect, advantage, embodiment and objective of the present invention to provide a method of online sales, wherein the posting to such first social network further comprises one member selected from the group consisting of: posting in a newsfeed, posting to a profile webpage, posting as a status update, other forms of social network posting now known or later devised and combinations thereof.

It is therefore another aspect, advantage, embodiment and objective of the present invention to provide a method of online sales, wherein the statement/opinion is endorsed by such first user.

It is therefore another aspect, advantage, embodiment and objective of the present invention to provide a method of online sales, wherein the statement/opinion is such first user's own statement/opinion.

It is therefore another aspect, advantage, embodiment and objective of the present invention to provide a method of online sales, further comprising: a shipping module operative to ship the first product to such first user, such point-of-checkout process operative to activate the shipping module.

It is therefore another aspect, advantage, embodiment and objective of the present invention to provide a method of online sales, wherein modules and components of the sales system are stored as programming in a non-volatile memory of a central processing unit.

It is therefore another aspect, advantage, embodiment and objective of the present invention to provide a method of online sales, for use with a second social network having a plurality of users and offering the users the ability to post to the social network, wherein: the POC advertisement provides an additional incentive for posting on more than one social network.

It is therefore another aspect, advantage, embodiment and objective of the present invention to provide a method of online sales, wherein the incentive to the first user is a function of one member selected from the group consisting of: a number of social network connections of such first user, a number of social network connections of such second user, a number of social networks to which such first user posts, a demographic indicia of such first user, a demographic indicia of such second user, and combinations thereof.

It is therefore another aspect, advantage, embodiment and objective of the present invention to provide a method of online sales, wherein the video component is pre-made and ready to be posted immediately by such first user.

It is therefore yet another aspect, advantage, embodiment and objective of the present invention to provide a method of online sales wherein the social advertisement selection module offers to such first user a plurality of social advertisement components and allows such first user to select which social advertisement component is posted.

Therefore it is yet another aspect, advantage, embodiment and objective of the present invention to provide a method of online sales wherein the video component features the first user and is created by the first user using the video selection module.

It is therefore yet another aspect, advantage, embodiment and objective of the present invention to provide a method of online sales wherein the video component is pre-made by a party selected from the group consisting of: an online merchant, a third-party hosting the sales system and combinations thereof.

It is therefore yet another aspect, advantage, embodiment and objective of the present invention to provide a method of online sales wherein such point-of-checkout process further comprises allowing such first user to designate the first product to be purchased, and requiring such first user to pay for the first product; and further wherein the sales system comprises: inserting the POC advertisement into such point-of-checkout process at a step selected from the group consisting of: prior to designation of the first product, after designation of the first product; prior to paying for the first product; while paying for the first product, after paying for the first product, and combinations thereof.

It is therefore yet another aspect, advantage, embodiment and objective of the present invention to provide a method of online sales wherein the social advertisement component further comprises: an offer to such second user of an incentive for purchasing the first product and posting information about the purchase of a first product by such second user.

It is therefore yet another aspect, advantage, embodiment and objective of the present invention to provide a method of online sales wherein the social advertisement component further comprises: an embedded component operative to register a click from such second user and in response to the click activate such point-of-checkout process for such second user to purchase the first product.

It is therefore yet another aspect, advantage, embodiment and objective of the present invention to provide a method of online sales further comprising completing purchase of the first product by the social network connection of the second user.

It is therefore another aspect, advantage, embodiment and objective of the present invention to provide a method of online sales, for a first user having a first social network connection to a second user, the first social network connection allowing posting to the first social network, the method comprising the steps of: inserting into a point-of-checkout process of a first product a first advertisement offering to such first user an incentive for posting to such first social network a second advertisement; if such first user accepts such incentive, then posting to such first social network the second advertisement.

It is therefore another aspect, advantage, embodiment and objective of the present invention to provide a method of online sales, wherein the second advertisement further comprises on member selected from the group consisting of: a video file, and embedded video player, a link to a video file, a link to a video player, a link to a video publically posted to a video sharing service and combinations thereof.

It is therefore yet another aspect, advantage, embodiment and objective of the present invention to provide a method of online sales, wherein such posting further comprises one member selected from the group consisting of: posting in a newsfeed, posting to a profile webpage, posting as a status update, other forms of social network posting now known or later devised and combinations thereof.

And it is therefore yet another aspect, advantage, embodiment and objective of the present invention to provide a method of online sales, further comprising the steps of: offering to such first user a plurality of social advertisement components; allowing such first user to select which social advertisement component is posted; posting a a companion advertisement component to such first social network as a post of such first user, the companion advertisement displayed along with the video component; shipping the first product to such first user, such point-of-checkout process operative to activate the shipping module; inserting the point-of-checkout advertisement into such point-of-checkout process at a step selected from the group consisting of: prior to designation of the first product, after designation of the first product; prior to paying for the first product; while paying for the first product, after paying for the first product, and combinations thereof.

It is therefore yet another aspect, advantage, embodiment and objective of the present invention to provide a method of online sales, wherein the incentive to the first user is a function of one member selected from the group consisting of: a number of social network connections of such first user, a number of social network connections of such second user, a number of social networks to which such first user posts, a demographic indicia of such first user, a demographic indicia of such second user, and combinations thereof.

It is therefore yet another aspect, advantage, embodiment and objective of the present invention to provide a method of online sales, wherein steps of the method are stored as programming in a non-volatile memory of a central processing unit.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control. These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is an informal flow chart illustrating possible steps in a method according to an embodiment of the invention.

FIG. 2 is a schematic diagram of the components of a system according to an embodiment of the invention.

FIG. 3 is an exemplary chart of the spread of an advertisement according to the invention, through a partial social network, shown as a hierarchy for simplicity and clarity though social networks are in fact not usually hierarchical in organization.

FIG. 4 is an exemplary block diagram of a partial social network in which users receive a score based upon their number of communication links with other users of the network.

FIG. 5 is a block diagram showing physical components of a social network: though the physical components are the least important part of such a network they are shown for reference purposes.

FIG. 6 is an exemplary tabular data structure showing potential video advertisements which a user might select from based upon various important dimensions of suitability.

FIG. 7 is an exemplary tabular data structure showing potential non-video advertisements which a user might select from based upon various important dimensions of suitability.

### INDEX OF REFERENCE NUMERALS

| | |
|---|---|
| Sales system | 100 |
| Products | 102 |
| Shopping cart | 104 |
| Incentive offer/POC Ad | 106 |
| Exemplary incentive offer | 108 |
| Decline | 110 |
| Accept offer | 112 |
| Checkout page | 114 |
| Social advertisement | 116 |
| Provide incentive | 118 |
| Post to social network | 120 |
| Viewing of incentive | 122 |
| Referred sale | 124 |
| First user/initial purchaser | 302 |
| Second user/wall/area | 304 |
| Companion advertisement | 306 |
| Video component | 308 |
| Third user | 310 |
| First user having 4 links | 402 |
| Second user having 0 links | 404 |
| Third user having 8 links | 406 |
| Third user rating: 8 | 408 |
| Fourth user | 410 |
| Fourth user rating: 32 | 412 |
| Social network/Internet | 502 |
| Merchant computer | 504 |
| Server computer w/NV mem | 506 |
| Consumer access device | 508 |
| Product (computer for sale) | 510 |
| Video component | 512 |
| Video selection module | 514 |
| Shipping module | 516 |
| User database | 518 |
| Other modules/components | 520 |
| Checkout screen/process | 1000 |
| Incentive offer/first (POC) Ad | 1100 |
| Link | 2100 |
| Video | 2200 |

### DETAILED DESCRIPTION OF EMBODIMENTS

Briefly and in general terms the present invention provides a system for encouraging an online shopper to share information about an online purchase transaction that includes an online advertisement and a video component featuring the product or a statement or opinion about the product in a video. The online advertisement is an incentive offer that initially appears to a first social network user at the point of checkout. The online advertisement indicates an incentive for sharing information about the purchase of the product (that has already been selected) on one or more social network platform. The video component featuring the product or a link thereto is configured to be displayed on the online shopper's social network platform as a posting in a newsfeed, on a profile webpage, or as a status update for one or more social network connection of the online shopper to see when the online shopper indicates a willingness to share in order to receive the incentive.

According to another embodiment provided is a method for encouraging an online shopper to share information about an online purchase transaction that includes offering an incentive to the online shopper and displaying a video featuring the product on a social network platform of the online shopper when the online shopper accepts the incentive. According to a preferred embodiment, the incentive is offered after an online product item has been added to an online shopping cart of the online shopper but prior to checkout.

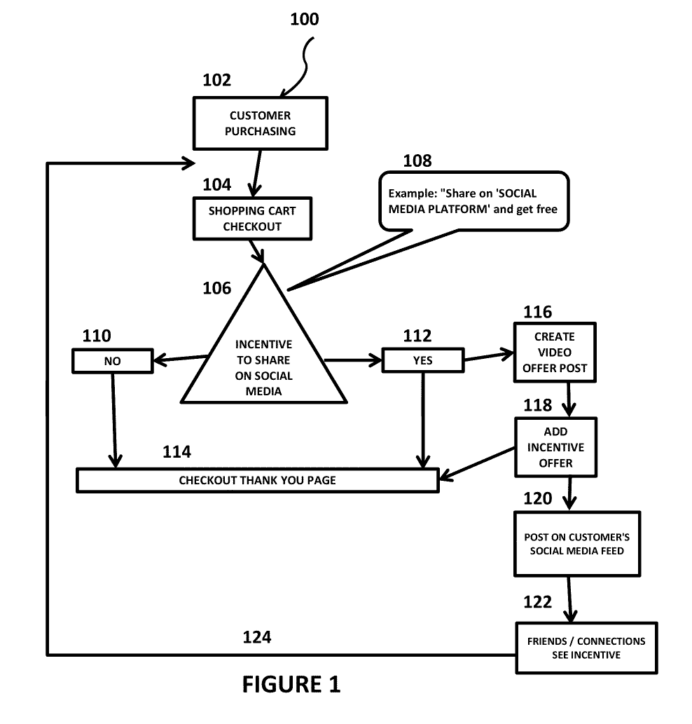

Referring now to the accompanying FIG. 1, a first embodiment 100 of the method is shown with the customer purchasing products 102 that end up in a virtual shopping cart 104 at the online checkout screen. At this point an incentive offer (e.g. discount, buy one get one free, etc.) appears 106 if the online shopper elects to redeem or take advantage of the incentive in exchange for sharing information about their purchase featuring the product with one or more social network connection on one or more social network platform. For example 108, the incentive could state something like “Share on SOCIAL MEDIA PLATFORM NAME and get free shipping!” If the online shopper is not interested in sharing 110, then he/she does not receive the incentive and progresses to the final checkout page 114.

However, if the online shopper is willing to share 112, then he/she is prompted to either choose one of several pre-made videos about the product to share on one or more of his/her social networks, or has the option to create their own video featuring the product or a statement/opinion about 116. The incentive offer is added 118 to the checkout total and next posted 120 on the online shopper's social network newsfeed, profile page, etc. along with the video. Social network connections or friends of the online shopper will then see 122 the video or a link thereto along with the incentive offer. Many will then be motivated to become purchasers themselves and the purchasing and sharing escalates to become viral.

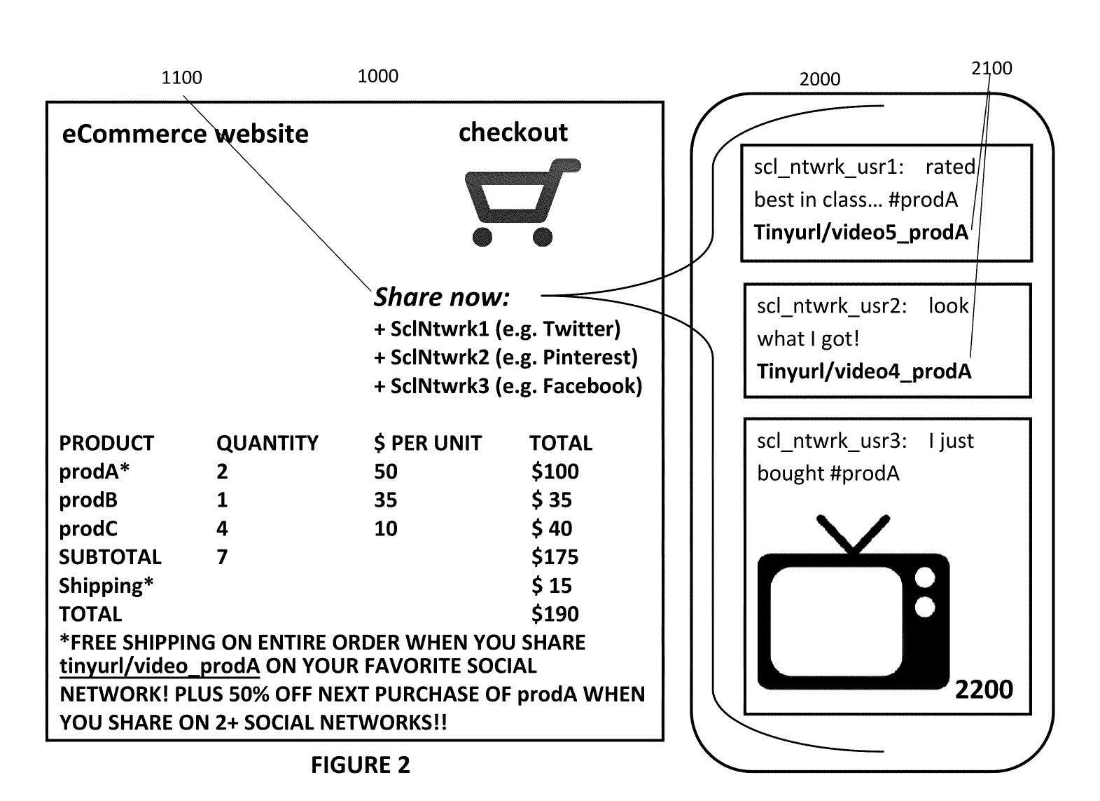

With reference to FIG. 2, a system according to an embodiment of the invention is shown to include an incentive offer or advertisement 1100 at the checkout screen 1000 of a website. When a shopper elects to redeem the incentive by sharing, a video 2200 featuring or promoting the product or a link 2100 thereto is posted on the shopper's newsfeed, profile webpage, etc. on a social networking website to which the online shopper belongs and where the online shopper has connections/contacts/friends/followers/etc. who will then see the news and be able to checkout the video of the product themselves. The incentive may be displayed again as well along with the video, in the video, or after clicking on the link to the video.

The video may also feature other additional products available for purchase with a few clicks and which may include further incentives for sharing or promoting across a purchaser's social network(s). As discussed above, the video may be selected according to the purchaser's taste and preference from one of several pre-made videos featuring the purchased product. Alternatively, the video may be created “on the fly” at the time of or after purchase by the purchaser, for example, featuring himself/herself as purchaser (“selfy”) with their smartphone camera. In other variations, static pictures may be selected or taken and shared to promote the product alternatively or additionally to dynamic videos.

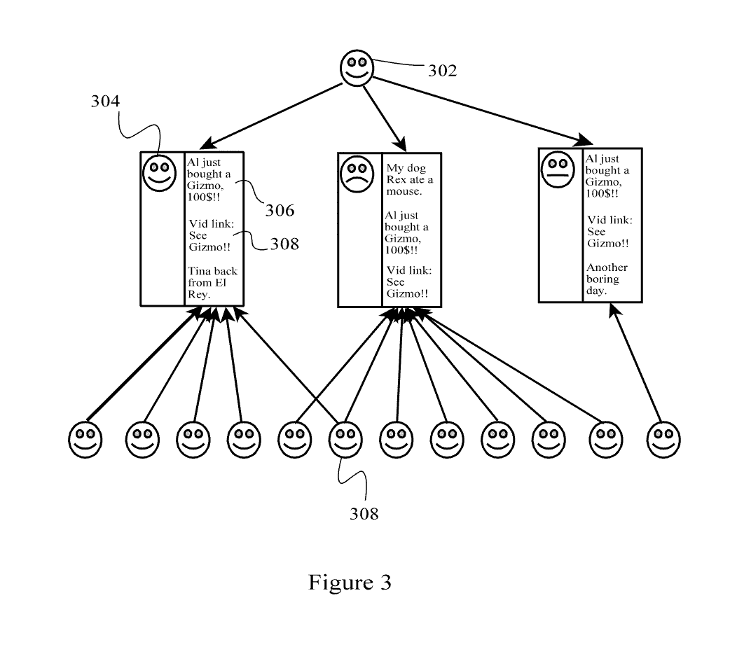

FIG. 3 is an exemplary chart of the spread of an advertisement according to the invention, through a partial social network, shown as a hierarchy for simplicity and clarity though social networks are in fact not usually hierarchical in organization. Also for simplicity, cross-discussions, replies, comments, off-line communication (DM) and other communications are not shown.

The particular diagram shown is for a hypothetical social network in which the rules are as follows: each user has an “area” or “bulletin board” or “wall” on which postings are placed: various example postings are shown along with the advertisement of the invention. However, postings are not placed by a first user themselves but rather by other users who the first user “follows” or “reposts” or “publishes”, that is, each user is encouraged under the rules of the social network to contribute to the areas of other users rather than their own. In turn, the areas on which such postings appear are seen by those (a third group) of users who “follow” the second user.

Thus, an example of the use of the invention shows first user/initial purchaser 302 posting on the area/wall of second user 304 both a companion advertisement 306 and a video component 308. This is in turn seen by third user 310. Note that in this example, third user 310 will actually get the same advertisement from two different sources, as he “follows” two different users who both follow first user 302.

Perhaps a more typical set of rules for a social network would be a rule in which each user posts to their own wall or area, however, the variation and use of the websites are extreme so all variations and embodiments are covered herein. If one imagines a situation in which the user 304 posts to his own wall, then the system can still be seen simply by ignoring 302 and other users below 302: instead, user 304 may post the comment, by means of the invention, to their own wall, where once again user 310 sees it. This simpler set of rules is one preferred embodiment and best mode now contemplated for carrying out the invention.

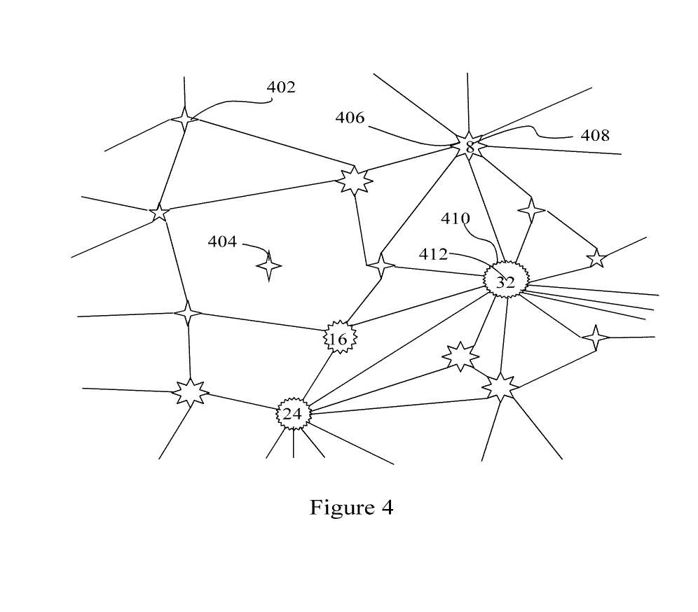

FIG. 4 is an exemplary block diagram of a partial social network in which users receive a score based upon their number of communication links with other users of the network. Since this is a partial view of a network, some connections are not shown, crossing connections are omitted and so on.

First user having 4 links 402 is represented by a small four pointed star. This individual might represent a fairly low use social networker, who is “followed” or “found” by only a handful of others. Second user having 0 links 404 may not be found at all.

However, third user having 8 links 406 is possibly about average for the social network, and has a score or rating assigned to them. Third user rating: “8” (408) may be seen to connect to a fourth user 410, who has a much larger number of contacts/followers/etc.

Fourth user rating: “32” (412) is the highest shown on this extremely simplified partial diagram, however, in real world social networks it is quite common to have hundreds of contacts/followers/friends/etc etc., and famous individuals or causes might have many millions. Obviously the present invention taps into the enormous potential of such power socializers: a single sale to such an individual might result in millions of views by other users.

It is thus very easy to see how an advertiser might make use of this information, which is often publically available. A simple method of scoring users might be to count their connections in the social network. Then the score might in turn be used to generate the level of incentive. For example, users 404 and 402 might not find any incentives when they go to purchase the first product (or designate it, for example by placing it in an electronic shopping cart), while user 406 might receive a nominal incentive (5% price discount, a small item, some small public recognition, membership, coupon, etc) while user 410 might receive a larger incentive: 10% off the price, a bonus item of more value, etc.

In addition, the number of contacts may be supplemented or supplanted by other methods of scoring users within the scope of the invention. For example, a greater incentive might be offered to those who post to more than a single social network. Similarly, other factors which might be used could include, but are not limited to, the number of social network connections of such first user, the number of social network connections of such second user to whom the first user is linked, a number of social networks to which such first user posts, a demographic indicia of such first user, a demographic indicia of such second user, and combinations thereof. Thus, user 406 might receive a large bonus due to being linked to user 410, who has larger score. Or, user 402 might represent an extremely desirable demographic, such as teens living in a particular zip code and thus receive a larger incentive offer.

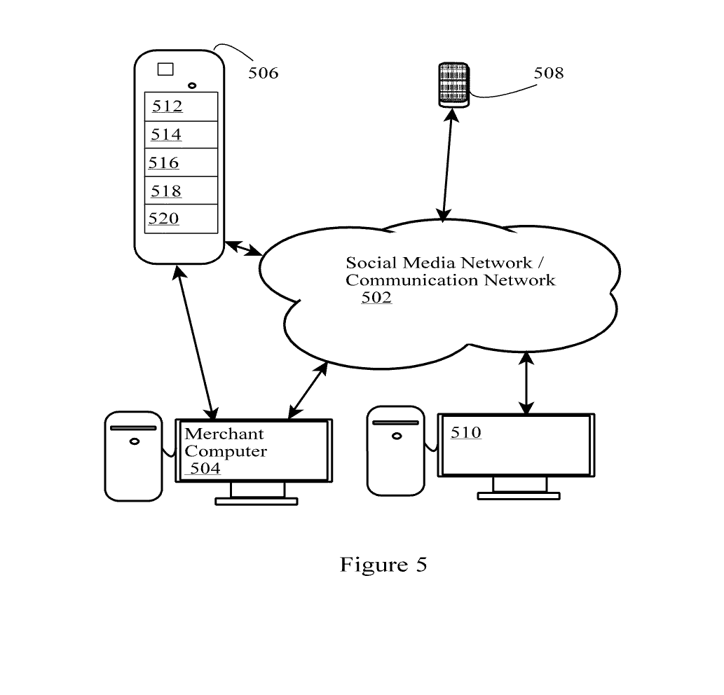

FIG. 5 is a block diagram showing physical components of a social network: though the physical components are the least important part of such a network they are shown for reference purposes. Social network/Internet 502 is not to be taken to indicate that social networks are confined to the Internet. Increasingly, “closed garden” communication protocols and product lineups are creating social networks which are not publically accessible. By volume of data transmitted as measured in gigabytes, it would seem that the private systems (such as those linked to the Apple corporation or the like) already are larger than the publically available Internet.

Merchant computer 504 may be used by a merchant to create pre-made videos of their own and otherwise manage the service, or a service provider of the social network advertising method of the invention might be creating the advertisements and managing the campaign from server computer having non-volatile memory 506, on which are programmed the components of the invention.

Consumer access device 508 is not shown as a traditional computer, although in fact it may be, simply because so many present day social network interactions and communications occur by means of portable devices such as phones, tablets, phablets, pads, pods and so on. Product (computer for sale) 510 may be seen to be displayed upon the social network in one advertisement form or another.

Video component 512 is one example format of advertisement, and the preferred embodiment and best mode now contemplated for carrying out the invention. Such a video may be arranged so that clicking on it takes a second user interested in the product to the point-of-checkout (POC) process, for example, by placing the advertised product into the second user's shopping cart. It may even, in conjunction with co-pending applications to the same inventors, provide the actual purchase of the product. Zzzz ONLY JPEG doesn't work, as it doesnt allow overlay of codec. HTML5 works, etc. All majors.

Part of the in video part is building our own player so we can control the checkout process more, maybe on the right while the video is playingzzzz. HE's sending me a video dec showing what it looks like. SEE JASON's video in “TEMP” file on Optima desktop. Page 11 of video (PDF) add the “share” as well. This video does not yet have the “post to purchase” fuxn in it but we'll add more about that too in this app. Small video (400×400) probably cannot do shopping cart in vid, so go to landing page of purchase website (eg Amazon cart). But can have cart in video in their proprietary player.
BOLD THE PARTS I CXHANGE AND SEND IT TO HIM. HE'll EMAIL IT BACK. ONE PATENT AT A TIME.

Video selection module 514 allows a user to select between different potential advertisements to display, as discussed previously in reference to FIG. 2, and further in reference to later figures. In FIG. 2, the topmost of advertisements 2100 might be considered suitable for a more business related social network such as LinkdIn, while the second ad might be more appropriate for a more personal social network, or one with image display, such as Instagram.

Shipping module 516 performs the physical activity of shipping the product 510 to the user 302 after purchase.

User database 518 is another necessary component of the invention, allowing the advertising service provider or the merchant to keep track of what consumers they are dealing with, the social network commitment level of those users (a term embracing a user's interest level, online capability, willingness to share, the usability of their preferred social tools and so on), demographic and financial information and much more.

Finally other modules and components are simplified for clarity as block 520, however, all other functions and components discussed herein may also be programmed into the non-volatile memory of the central processor unit (computer) of server 506.

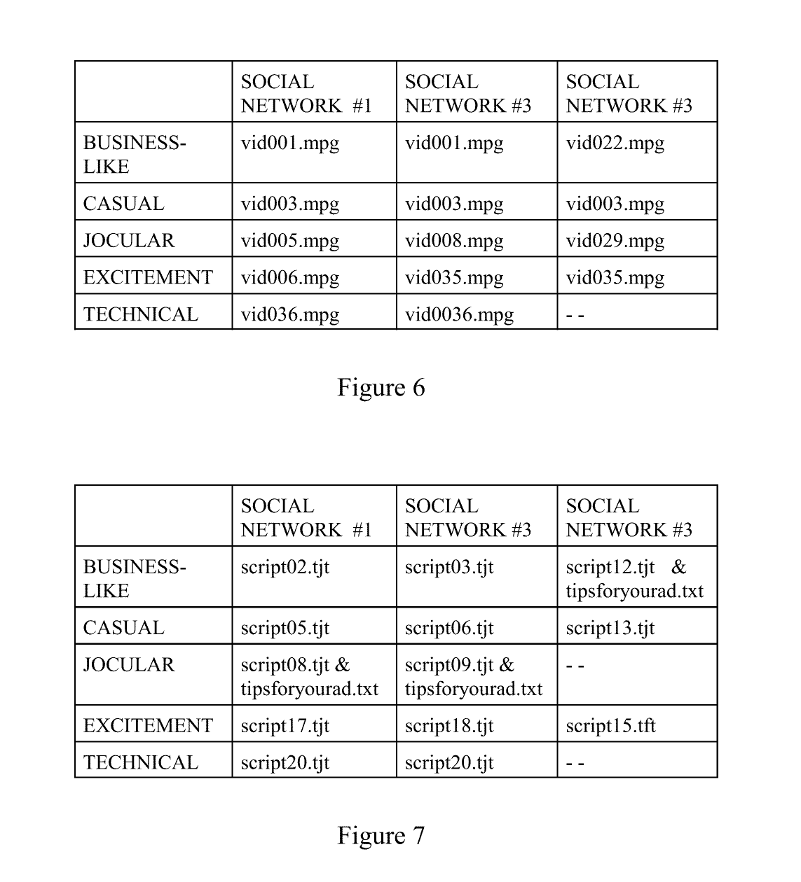

FIG. 6 is an exemplary tabular data structure showing potential video advertisements which a user might select from based upon various important dimensions of suitability. Thus, a user might decide that they want a business-like tone for their business oriented social network #3, and thus for that network choose to publish video vid022.mpg. Another network however, network #2, is seen by the same user's friends and an exited tone is appropriate for the purchase, so the user selects vid035.mpg for that particular advertisement. Not all cells of the array are necessarily present: there may be no useful video for the intersection of the business network #3 and a technical discussion.

In addition, the data structure shown is a two dimensional array but the invention is not in any way so limited. The actual dimensions on which the user might be offered choice would naturally include not just social network and tone but might also include product related choices, network topics of discussion, demographics of the friends on the network, and much more.

FIG. 7 is an exemplary tabular data structure showing potential non-video advertisements, or self-made advertisements or selfies, which a user might select from based upon various important dimensions of suitability. Thus, a user might want to put a script advertisement on social network #3, but would not desire to do so without the help of a pre-written script (script12.tjt) and a file of tips on how to make a video or post an appropriate ad: “tipsforyourad.txt”.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A sales system for encouraging an online shopper to share information about an online purchase transaction, the sales system for use with a first social network, the first social network having a plurality of users including first and second users, the first social network offering such users the ability to post to the first social network, the sales system further for use with an online purchase system, the online purchase system having a point-of-checkout process, the sales system comprising:
a POC advertisement inserted into such point-of-checkout process, the POC advertisement offering to such first user an incentive for posting information about the purchase of a first product by such first user;
a social advertisement selection module offering to such first user at least one social advertisement component for the sharing of information, the social advertisement component having a statement/opinion about the product;
a social advertisement component insertion module which posts the social advertisement component to the first social network as a post of such first user.

2. The sales system of claim 1, wherein the social advertisement component further comprises a video component and the social advertisement selection module further comprises a video selection module and the social advertisement component insertion module further comprises a video component insertion module.

3. The sales system of claim 2, wherein the social advertisement component insertion module further posts a companion advertisement component to such first social network as a post of such first user, the companion advertisement displayed along with the video component.

4. The sales system of claim 2, wherein the video component is one member selected from the group consisting of: a video file, and embedded video player, a link to a video file, a link to a video player, a link to a video publically posted to a video sharing service and combinations thereof.

5. The sales system of claim 2, wherein the posting to such first social network further comprises one member selected from the group consisting of: posting in a newsfeed, posting to a profile webpage, posting as a status update, other forms of social network posting now known or later devised and combinations thereof.

6. The sales system of claim 2, wherein the statement/opinion is endorsed by such first user.

7. The sales system of claim 2, wherein the statement/opinion is such first user's own statement/opinion.

8. The sales system of claim 2, further comprising:
a shipping module operative to ship the first product to such first user, such point-of-checkout process operative to activate the shipping module.

9. The sales system of claim 2, wherein modules and components of the sales system are stored as programming in a non-volatile memory of a central processing unit.

10. The sales system of claim 2, for use with a second social network having a plurality of users and offering the users the ability to post to the social network, wherein: the POC advertisement provides an additional incentive for posting on more than one social network.

11. The sales system of claim 2, wherein the incentive to the first user is a function of one member selected from the group consisting of: a number of social network connections of such first user, a number of social network connections of such second user, a number of social networks to which such first user posts, a demographic indicia of such first user, a demographic indicia of such second user, and combinations thereof.

12. The sales system of claim 2, wherein the video component is pre-made and ready to be posted immediately by such first user.

13. The sales system of claim 1, wherein the social advertisement selection module offers to such first user a plurality of social advertisement components and allows such first user to select which social advertisement component is posted.

14. The sales system of claim 2, wherein the video component features the first user and is created by the first user using the video selection module.

15. The sales system of claim 12, wherein the video component is pre-made by a party selected from the group consisting of: an online merchant, a third-party hosting the sales system and combinations thereof.

16. The sales system of claim 2, wherein such point-of-checkout process further comprises allowing such first user to designate the first product to be purchased, and requiring such first user to pay for the first product; and further wherein the sales system comprises:
inserting the POC advertisement into such point-of-checkout process at a step selected from the group consisting of: prior to designation of the first product, after designation of the first product; prior to paying for the first product; while paying for the first product, after paying for the first product, and combinations thereof.

17. The sales system of claim 1, wherein the social advertisement component further comprises: an offer to such second user of an incentive for purchasing the first product and posting information about the purchase of a first product by such second user.

18. The sales system of claim 1, wherein the social advertisement component further comprises: an embedded component operative to register a click from such second user and in response to the click activate such point-of-checkout process for such second user to purchase the first product.

19. The sales system of claim 18, further comprising completing purchase of the first product by the social network connection of the second user.

20. A method of online sales for a first user having a first social network connection to a second user, the first social network connection allowing posting to the first social network, the method comprising the steps of:
inserting into a point-of-checkout process of a first product a first advertisement offering to such first user an incentive for posting to such first social network a second advertisement;
if such first user accepts such incentive, then posting to such first social network the second advertisement.

21. The method of online sales of claim 20, wherein the second advertisement further comprises on member selected from the group consisting of: a video file, and embedded video player, a link to a video file, a link to a video player, a link to a video publically posted to a video sharing service and combinations thereof.

22. The method of online sales of claim 21, wherein such posting further comprises one member selected from the group consisting of: posting in a newsfeed, posting to a profile webpage, posting as a status update, other forms of social network posting now known or later devised and combinations thereof.

23. The method of online sales of claim 21, further comprising the steps of:
offering to such first user a plurality of social advertisement components;
allowing such first user to select which social advertisement component is posted;
posting a a companion advertisement component to such first social network as a post of such first user, the companion advertisement displayed along with the video component;
shipping the first product to such first user, such point-of-checkout process operative to activate the shipping module;
inserting the point-of-checkout advertisement into such point-of-checkout process at a step selected from the group consisting of: prior to designation of the first product, after designation of the first product; prior to paying for the first product;
while paying for the first product, after paying for the first product, and combinations thereof.

24. The method of online sales of claim 21, wherein the incentive to the first user is a function of one member selected from the group consisting of: a number of social network connections of such first user, a number of social network connections of such second user, a number of social networks to which such first user posts, a demographic indicia of such first user, a demographic indicia of such second user, and combinations thereof.

25. The method of online sales of claim 21, wherein steps of the method are stored as programming in a non-volatile memory of a central processing unit.
